(19) United States
(12) Patent Application Publication
(10) Pub. No.: US 2026/0197193 A1
(43) Pub. Date: Jul. 9, 2026

(54) System and Method for Enhancing Information Flow in Presentations

(71) Applicant: James Wen, Oslo (NO)

(72) Inventor: James Wen, Oslo (NO)

(21) Appl. No.: 19/008,665

(22) Filed: Jan. 3, 2025

(51) Int. Cl. H04L 12/18; G06F 3/0481

(52) U.S. Cl. CPC H04L 12/1822; G06F 3/0481; H04L 12/1831

(57) ABSTRACT

The present invention relates to a system and method for enhancing audience engagement and information flow during presentations, lectures, and educational sessions. The system allows a presenter to track the collective understanding of listeners in real-time through an unobtrusive, anonymous feedback mechanism. Listeners can submit status indicators, such as confusion signals, using personal devices connected to a centralized computing system. These indicators are aggregated and visualized dynamically on a shared display, visible to both the presenter and the audience. The system enables spontaneous polling, allowing presenters to initiate and display questions without prior setup, enhancing adaptability during sessions. Additionally, the invention supports machine learning algorithms to analyze feedback patterns and suggest real-time adjustments to presentation pacing and content. A dual-database configuration ensures audience anonymity by separating personally identifiable information from feedback data. The invention facilitates increased engagement, providing presenters with immediate insights into audience comprehension.

### 1. FIELD OF THE INVENTION

The present invention relates to educational technology, specifically to classroom response and polling systems that enhance real-time interaction between students and teachers.

### 2. BACKGROUND AND PRIOR ART

Classroom response and polling systems—or Classroom Response Systems (CRS) for short—have been shown to be effective tools for promoting student engagement. Such systems allow students to reply to questions anonymously and replaces the often intimidating act for a student to raise a hand, often without full confidence and in front of peers, in response to a teacher asking for a “show of hands” in answer to a challenging question.

U.S. Patent Application US20130164725A1, titled “Classroom Response System,” describes a system comprising a server, instructor consoles, and student consoles. The system enables instructors to manage classroom interactions, including posing questions and receiving student responses, with features like attendance tracking and open-ended answer collection. The patent does not explicitly mention spontaneous polling capabilities or features that allow students to initiate communication with the instructor. The described functionalities focus on instructor-led interactions, such as posing questions and collecting responses, without provisions for student-initiated inputs or spontaneous polling initiated by the instructor during a session.

U.S. Patent Application US20210201688A1, titled “Real Time Formative Assessment and Lesson Plan Recommendation With Remedial Learning Assessment,” describes a system that enables real-time formative assessments in educational settings. The system allows instructors to pose questions to students, collect their responses via polling hardware, and analyze the data to identify misconceptions. Based on this analysis, the system can recommend modifications to lesson plans to address identified learning gaps. The primary focus is on instructor-initiated assessments and subsequent instructional adjustments. The application does not detail features for student-initiated communication or spontaneous polling initiated by students.

U.S. Patent Application US20170352285A1, titled “System and Method of Monitoring Behavior and Engagement of Students,” describes a networked system connecting an instructor's device with one or more student devices. The system monitors sensors in student devices to assess engagement levels and detect distractions. Instructors can set operational parameters, and the system alerts them to any deviations, promoting attentive behavior. While the system focuses on monitoring and managing student engagement, it does not provide features for spontaneous polling or student-initiated communication.

U.S. Patent Application US20120202185A1, titled “System and Method for Wireless Communication in an Educational Setting,” describes a system that facilitates wireless communication between instructors and students within a classroom environment. The system enables instructors to send questions or prompts to students' devices, allowing students to respond in real-time. Additionally, it provides a mechanism for students to initiate communication with the instructor, such as submitting questions or indicating confusion during a lesson. This bidirectional communication enhances interactive learning by allowing both instructor-initiated and student-initiated interactions.

U.S. Patent Application US20110300526A1, titled “Systems and Methods for Facilitating Classroom Interaction,” describes a system that enables students to submit questions or comments during a class session using their devices. These submissions are sent to the instructor's device, allowing the teacher to address them in real-time or at a later point. This system facilitates student-initiated communication, enabling learners to seek clarification or contribute input during lessons.

U.S. Patent Application US20230123893A1, titled “Systems and Methods to Cooperatively Perform Virtual Actions,” describes a system that enables multiple users to collaboratively control virtual activities. The system allows one user to initiate a virtual action, which then informs other users, facilitating cooperative engagement in virtual environments. While the focus is on shared virtual experiences, the application does not specifically address classroom polling or student-initiated communication features.

U.S. Patent Application US20060294216A1, titled “Wireless Classroom Response System,” describes a system comprising multiple wireless networks, each serving a different classroom. Each network includes a computer executing a communications server and an application program to facilitate classroom activities, a wireless access point linked to the computer, and multiple handheld units for students. Students can select the appropriate network and transmit data to the application program via the wireless access point. The system focuses on instructor-initiated interactions and does not detail features for student-initiated communication or spontaneous polling initiated by students.

U.S. Pat. No. 7,924,759, titled “Validation Method for Transmitting Data in a Two-Way Audience Response Teaching System,” was granted on Apr. 12, 2011. This patent describes a system where students use remote devices to send responses to a central receiver during instructional sessions. The system includes a validation method to ensure the accuracy and integrity of the transmitted data. While it facilitates two-way communication, the primary focus is on validating data transmission rather than enabling spontaneous polling or student-initiated communication.

U.S. Pat. No. 11,335,206, titled “Classroom Educational Response System and Pedagogical Method,” was granted on May 17, 2022. This patent describes a system that enables students to initiate communication with the teacher by selecting from multiple colored lights on a device, each representing a different response or question type. The system allows for real-time, student-initiated interactions, facilitating immediate feedback and engagement during classroom sessions. Additionally, it supports teacher-initiated polling, providing a dynamic and interactive educational environment.

U.S. Pat. No. 7,286,498, titled “Validation Method and Data Structures for Wireless Response System,” was granted on Oct. 23, 2007. This patent describes a wireless response system where students use remote devices to send responses to a central receiver during instructional sessions. The system includes a validation method to ensure the accuracy and integrity of the transmitted data. While it facilitates two-way communication, the primary focus is on validating data transmission rather than enabling spontaneous polling or student-initiated communication.

In addition to the patents described, a number of commercial products on the market serve as CRS and are relevant prior art. iClicker is a well-established classroom response system that utilizes both physical clickers and digital interfaces to enable student participation in quizzes and polls. Teachers pre-set questions or deploy them during presentations, and students can respond using their devices. However, iClicker does not offer functionality for students to initiate communication with the teacher independently. It also restricts teachers from adding impromptu questions without preparation in advance, which may limit their flexibility in addressing real-time learning challenges.

Poll Everywhere offers various question types such as multiple-choice, Q&A, word clouds, and clickable images. While it provides a platform for students to submit answers anonymously, students cannot independently initiate new communications with the teacher or classmates. Teachers must also prepare their questions beforehand in the Poll Everywhere interface, as adding spontaneous questions during a lesson requires navigating away from the main presentation, which can disrupt the flow.

AhaSlides is known for its diverse interactive features, including quizzes, word clouds, and brainstorming tools. It allows students to engage at their own pace via open-ended questions or brainstorming prompts. However, the lack of a feature for students to initiate communication or send specific feedback signals to the teacher remains a limitation. Additionally, while the platform supports interactive elements, spontaneous question creation by teachers is restricted, requiring them to have questions prepared in the system or pause the presentation to add new prompts.

Acadly integrates attendance tracking and classroom response functionalities, offering dedicated chat channels for each activity where students can ask questions related to specific poll topics. While this adds some flexibility for students to communicate, the chats are confined to pre-defined activities, and students still cannot signal issues outside of these parameters. For teachers, Acadly also requires setup for each question in advance, and adding new questions during the lecture can disrupt classroom continuity.

In all the prior art, students have no mechanism to signal confusion or initiate questions independently, which could be particularly helpful in large classrooms where direct communication is challenging. The absence of a simple feedback mechanism, such as a “Confused” button or a way to request clarification, leaves students dependent on the teacher's polling prompts, limiting the opportunity for individualized support. Furthermore, while some platforms allow flexibility in question types, the need for pre-setting questions remains a barrier to real-time, adaptive teaching. Teachers who wish to assess understanding spontaneously or adapt questions based on class dynamics must either prepare all potential questions in advance or pause the class to navigate the polling interface, both of which can disrupt engagement and reduce the spontaneity that could enhance learning.

It can be seen there is a need in CRS to enable spontaneous, two-way communication. A system allowing students to signal confusion or initiate communication would address significant interaction limitations and empower students to seek support discreetly. Additionally, a feature that allows teachers to spontaneously create and deploy polls without pre-planning would provide more adaptive teaching capabilities, enhancing real-time responsiveness to student needs.

### 3. BRIEF SUMMARY OF THE INVENTION

Accordingly, it is the intent of this disclosure to describe a system for use in a setting where a presenter and an audience are present and the state of mind of the audience members is of interest to the presenter. The disclosed invention provides a channel of communication initiated by individual members of the audience through an interface that can provide anonymity while informing the presenter of the state of the audience. The disclosed invention also allows the presenter to ask the audience questions at any time where the audience responses can be displayed for all to see without prior integration into a structured presentation so that the presenter can effectively assess the state of the audience at any time with respect to how well the presentation is being understood. The invention further incorporates mechanisms to analyze patterns in audience feedback and recommend real-time adjustments, enhancing the presenter's ability to respond dynamically to the needs of the audience.

### 4. OBJECTS AND ADVANTAGES

It is an objective of the present invention to promote an inclusive presentation environment through a system that enables audience members to initiate requests for clarification or indicate confusion directly from their devices without revealing their need.

It is another objective of the present invention to facilitate spontaneous polls in a presentation by providing an interface for presenters to create and launch polls spontaneously and without a need to create the polls in advance of the presentation.

It is yet another objective of the present invention to provide an aggregated display that could be shown on a public screen or device, providing both the presenter and audience with immediate insights into the collective understanding of the audience.

It is still another objective of the present invention to encourage and improve audience engagement by incorporating options for anonymous responses and private signals to foster a supportive and inclusive learning environment.

It is yet still another objective of the present invention to enhance presenter responsiveness by providing instant feedback of data submitted by the audience without notifying any members of the audience.

It is still yet another objective of the present invention to serve a large audience by providing seamless integration with a wide range of networked devices, including smartphones, tablets, and computers to maximize compatibility in environments with diverse hardware.

It is also another objective of the present invention to enable unobtrusive interaction, allowing listeners to signal confusion or respond to spontaneous polls at their discretion, fostering engagement without disrupting the flow of the presentation.

It is also yet another objective of the present invention to incorporate adaptive learning mechanisms to analyze patterns in audience feedback and recommend real-time adjustments, enhancing the presenter's ability to respond dynamically to the needs of the audience.

It is also still another objective of the present invention to separate personally identifiable information from session feedback ensuring privacy while providing presenters with valuable real-time insights into audience engagement.

### 5. BRIEF DESCRIPTION OF THE DRAWINGS

The features and advantages of the disclosed invention as well as additional features and advantages thereof will be more clearly understood hereinafter as a result of a detailed description or particular embodiments of the invention when taken in conjunction with the following drawings in which:

FIG. 1 illustrates an overview of the exemplary operating environment including a computer-based controller component, a projection system, a database component, and a plurality of client devices.

FIG. 2A-2D illustrate exemplary layouts for the controller component interface.

FIG. 3A-3B depict exemplary renderings of the shared view display

FIG. 4A-4C illustrate exemplary layouts for the client component interface.

FIG. 5 is a flowchart illustrating the operation of the preferred embodiment of the present invention

FIG. 6 illustrates an exemplary rendering of a multiple choice results shown on the shared view display

FIG. 7 illustrates an exemplary rendering of a histogram showing the activities related to the actuation of the confused button during a presentation.

FIG. 8 illustrates how an adaptive learning analysis of the aggregate confusion level triggers suggestions to the presenter.

### 6. DETAILED DESCRIPTION OF THE INVENTION

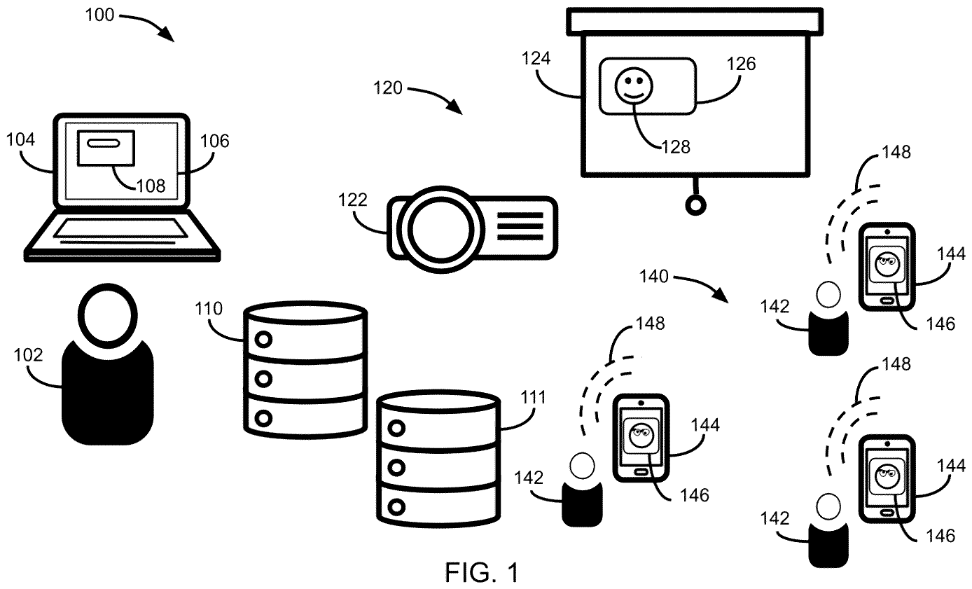

Referring to FIG. 1, in the preferred embodiment of the present invention, a system for enhancing information flow in lectures 100 is intended to be controlled by a presenter 102 and is primarily resident on a computing device 104, computing device 104 including a display 106 capable of rendering controller interface 108 for viewing and controlling by presenter 102.

Computing device 104 is connected to a database and centralized computing system 110 through a wireless connection in the preferred embodiment. In other embodiments, the connection could be through a wired network and, in still other embodiments, computing device 104 and centralized computing system 110 may reside on the same hardware. Database and centralized computing system 110 is capable of storing data and retrieving data for rendering from computing device 104 automatically through programmatic commands or by presenter 102 through controller interface 108 on display 106.

A shared display system 120 includes, in the preferred embodiment, a projector 122 and a shared display 124 where projector 122 can receive data from computing device 104 through wireless connections. In alternative embodiments, projector 122 and shared display 124 may be a single unit in the form of a large screen LED display and in still other embodiments, projector 122 can receive data from computing device 104 through wired connections. Many such connection possibilities exist and are well known to those skilled in the arts.

Computing device 104 is capable of transmitting data to projector 122 to display shared view 126, shared view 126 including, in the preferred embodiment, a graphical cue 128 reflecting state of audience, on shared display 124. Shared view 126 is visible to both presenter 102 and audience of listeners 140. In the context of this invention, the term “listener” refers to an individual present during a lecture or interactive session. A listener may engage in the session by submitting feedback through the system, but such engagement is voluntary and non-disruptive to the listener's primary role as an observer. This definition allows for the natural progression from passive listening to active participation without imposing an expectation of continuous interaction. The system is designed to facilitate unobtrusive feedback mechanisms that allow listeners to indicate levels of understanding or confusion at their discretion. By incorporating interactive elements, the system enhances the listening experience without fundamentally altering the nature of the session for those who prefer to remain passive observers.

In some embodiments, in addition or in place of, a single display viewable by presenter 102 and the audience members, projection system 120 can transmit the shared content synchronously to all audience members directly to personal displays rather than rely on a physically shared viewing screen, such as shared display 124. However, in the preferred embodiment, a shared display 124 is used to provide a view surface for the content projected by projector 122. Content projected onto shared display 124 can be seen by everyone, including presenter 102 and audience of listeners 140.

Each listener 142 from audience of listeners 140 has a client device 144, client device 144 capable of transmitting and receiving data from database and centralized computing system 110. In the preferred embodiment, wireless connections 148 are used to transmit and receive data to and from, respectively, client device 144 and the database and centralized computing system 110. In other embodiments, wired connections can be used to transmit or receive data from and to client devices 144. In some embodiments, client device 144 can be a smartphone capable of wireless communication. In other embodiments, client device 144 can be a laptop computer capable of both wired and wireless communication. In general, each audience member may have a different form of client device 144 capable of transmitting and receiving data from database and centralized computing system 110 and displaying client interface 146.

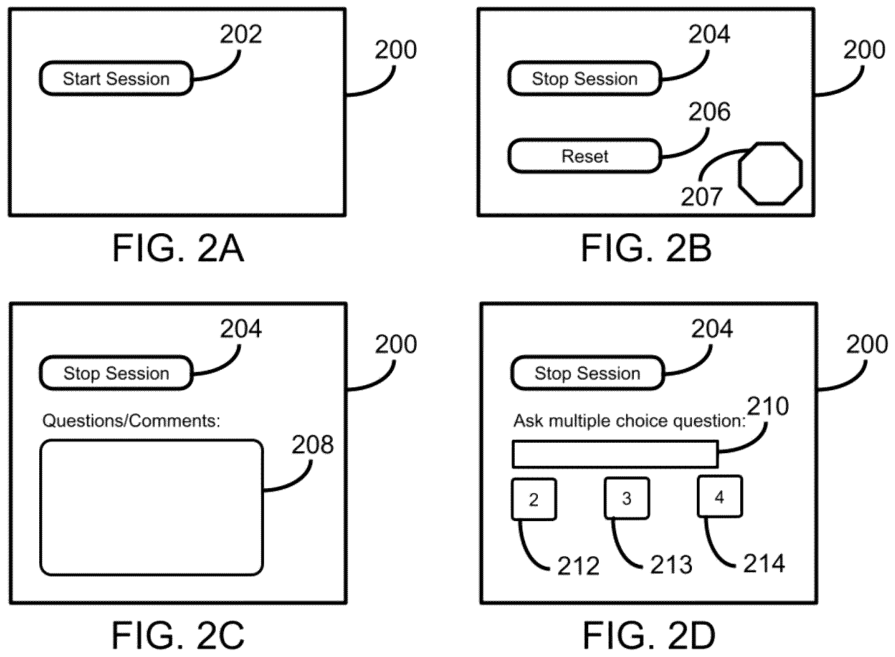

Referring now to FIG. 2A as well as FIG. 1, interface 108 shown on display 106, is magnified as interface 200 and provides presenter 102 the ability to begin an information flow enhancement session at the start of a presentation through a start button 202. In the preferred embodiment, after start button 202 is selected, button 202 is replaced by subsequent interface elements stop button 204 and reset button 206, as shown in FIG. 2B.

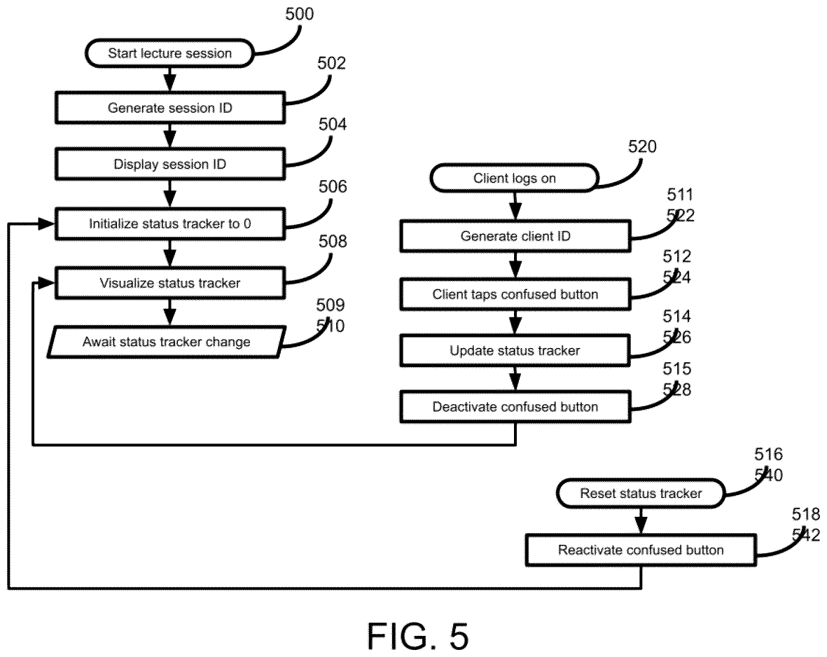

Referring now to FIG. 5, as well as FIG. 1 and FIG. 2A, in the preferred embodiment, when presenter 102 chooses to begin a session, button 202 is selected, and operation is begun at a step 500. At a step 502, a unique session ID is generated in database and centralized computing system 110 which can be used to connect devices to the newly initiated session.

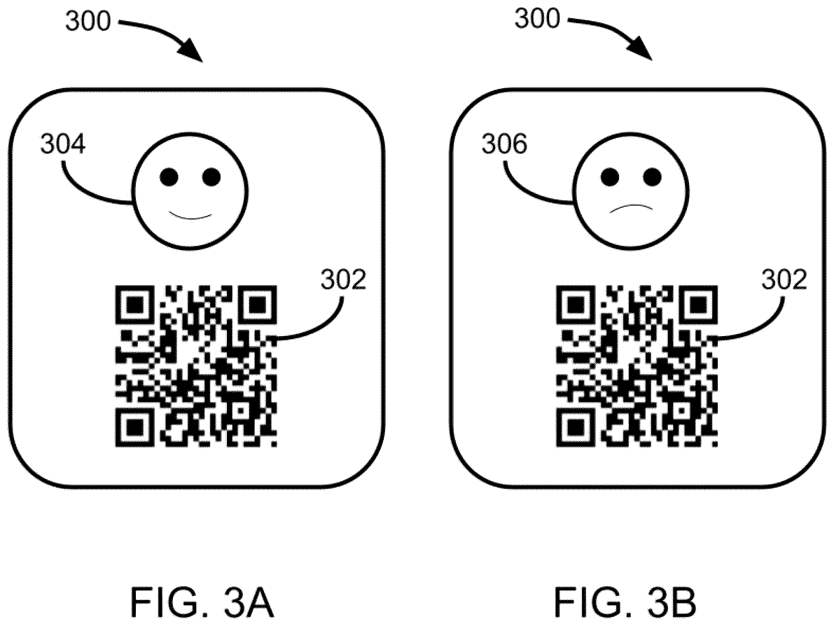

Referring now to FIG. 3A as well as FIG. 1 and FIG. 5, in the preferred embodiment, the unique session ID can be encoded within a QR code 302. A step 504 will render the QR code for display on shared view 300. In the preferred embodiment, the camera feature on the device of listener 142 can be used to scan the unique pattern of QR code 302 which would establish a connection to an address on the network. In some embodiments, the mobile devices are smartphones while in other embodiments, the mobile devices can be laptop computers, tablet computers, augmented reality eyewear or other web browser-enabled devices known to those skilled in the arts. In still other embodiments, a human readable code can be rendered so that users without devices to scan QR code patterns can establish a connection using the code. These and other similar methods to establish a network connection are well known to those skilled in the arts.

A status tracker is initialized to 0 in database and centralized computing system 110 at a step 506. The status tracker is intended to be used by the presenter to track the status of the audience of listeners based on a predefined metric. In the preferred embodiment, the metric can be interpreted as an integer rating representing the degree of confusion by the audience so that the higher the number the more confused the audience is considered to be.

Referring now to FIG. 3A as well as FIG. 1 and FIG. 5, a visualization of the status tracker is made at a step 508 so as to be visible to presenter 102 as well as audience of listeners 140 through shared view 126 and is shown in greater detail as shared view 300. Shared view 126, status visualization 128 and status tracker visualization 304 of shared view 300 represent the same visualization of the status tracker, but with different details. In the preferred embodiment, the visualization can take the form of a smiley face with the size of the smile indicating the degree of confusion. In other embodiments, the visualization can be a rendered number reflecting the status tracker representing the degree of interest the audience has in the presentation, with a higher integer value indicating a higher degree of interest. In still other embodiments, the status tracker can be an aggregate of values, each measuring a quality of the audience that is volunteered by the audience. The definition of the status tracker can vary depending on the nature of the presentation as well as the nature of the audience and can be modified as needed by those skilled in the arts.

At this point, a step 510 places the system in a wait state for any external activity to trigger an action in response. This could mean that the process running the application executing on computing device 104 and the process running the application on database and centralized computing system 110 minimize use of processing cycles until presenter 102 interacts with controller interface 108 creates an external activity or listener 142 interacts with client interface 146.

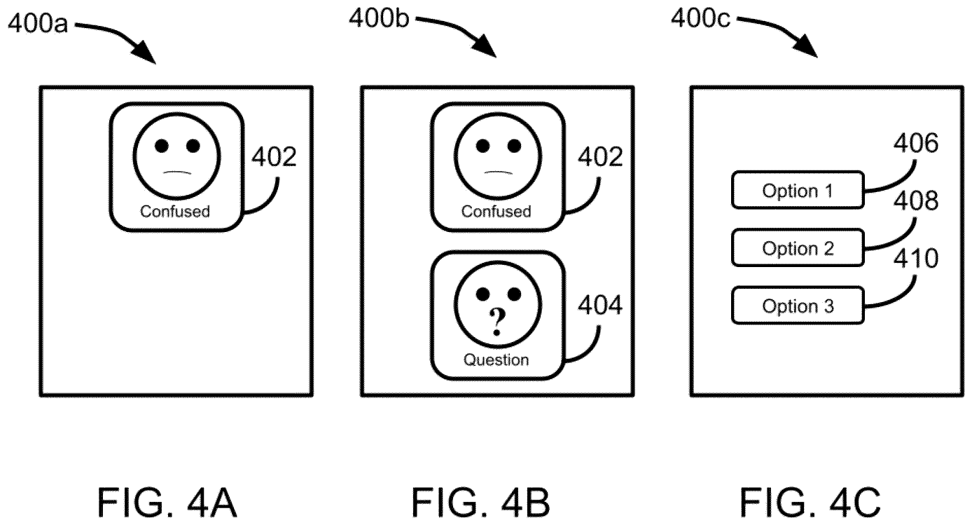

Referring now to FIG. 4A as well as FIG. 1, FIG. 3, and FIG. 5, listener 142 connects to the session created by presenter 102 using QR code 302 in a step 520. A client ID is generated by database and centralized computing system 110 in a step 522 uniquely but anonymously identifying listener 142 to database and centralized computing system 110. After the successful login, listener 142 of audience of listeners 140 is shown a client interface 400a. In the preferred embodiment, client interface 400a shows a confused button 402.

Referring still to FIG. 1, FIG. 4A, and FIG. 5, whenever listener 142 feels confused and would like presenter 102 to respond to the confusion without having to reveal their shortcoming in front of their peers, listener 142 can actuate button 402 in a step 524, sending a status indicator value to database and centralized computing system 110. A step 526 updates status tracker to reflect the addition of a confused listener in the session.

In the preferred embodiment, after listener 102 has actuated confused button 402, confused button 402 is deactivated in a step 528 until presenter 102 resets the system. In this way, no one can express confusion multiple times unless allowed by presenter 102.

Referring now to FIG. 3A and FIG. 3B as well as FIG. 1 and FIG. 5, satisfied visual cue 304 is transformed into confused visual cue 306, viewable by presenter 102 and audience of listeners 140, including listener 142, as control returns to step 508.

Referring now to FIG. 2B as well as FIG. 1, in the preferred embodiment, database and centralized computing system 110 can track the number of times confusion button 402 is actuated in order to determine the degree of overall confusion in the presentation. In a helpful embodiment, machine learning algorithms are used that can identify feedback patterns and match them against the most helpful adjustments, database and centralized computing system 110 can suggest to presenter 102 the best remedial action to take to clarify the confusion.

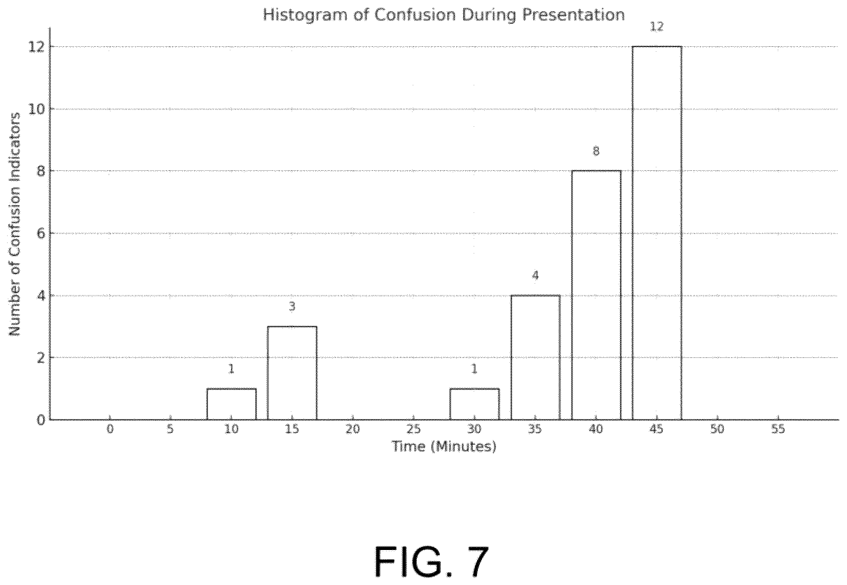

Referring now to FIG. 7 as well as FIG. 1, in the preferred embodiment, the actuation of confused button 402 or comment button 404 may be recorded and stored in database and centralized computing system 110 for later analysis. For example, presenter 102 may wish to analyze the presentation after completing the presentation by examining the points during which the most activity was recorded for actuation of confused button 402 and/or comment button 404. Such data can be aggregated into analytical reports to showcase activities that can be interpreted as engagement metric for the presenter.

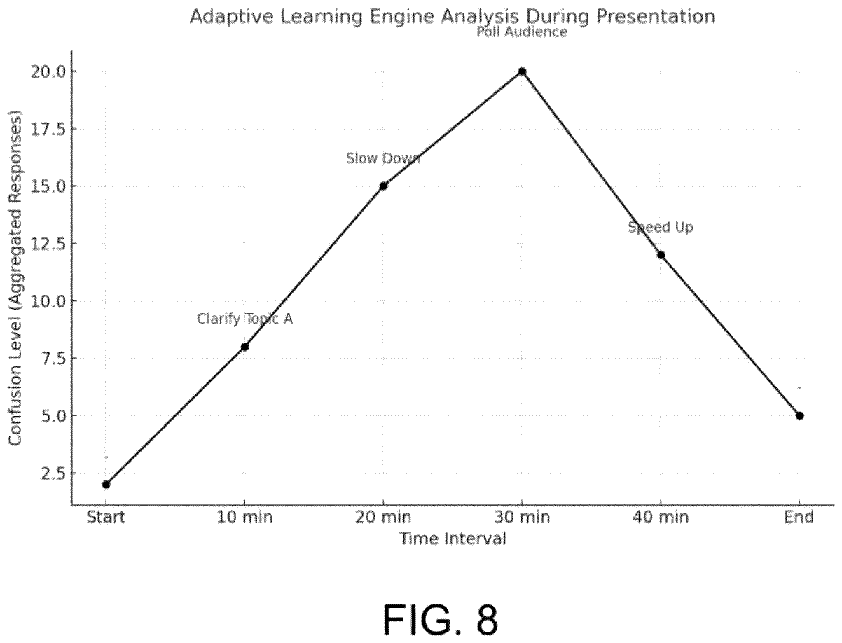

Referring now to FIG. 8 as well as FIG. 1 and FIG. 7, a learning embodiment includes an adaptive learning engine integrated into centralized computing system 110. The engine analyzes incoming feedback from listeners over the course of the session to detect patterns of confusion or disengagement. As illustrated in FIG. 8, aggregated confusion indicators are tracked at different time intervals throughout the presentation. At each interval, the adaptive learning engine processes the current status of the audience and suggests actions to the presenter through visual cues. In the example shown:
At 10 minutes, the confusion level rises to 8, prompting the system to recommend clarifying Topic A.
At 20 minutes, confusion peaks at 15, resulting in a suggestion to slow down the presentation.
At 30 minutes, the system identifies increased engagement but lingering confusion, recommending a poll of the audience.
By 40 minutes, confusion subsides, and the engine suggests the presenter may speed up to maintain momentum.

This real-time feedback loop allows the presenter to dynamically adjust the pace and content of the presentation. enhancing audience comprehension and engagement. The adaptive learning engine uses historical session data to refine future recommendations, improving accuracy over time. Machine learning models are trained on previous session data to predict the most effective intervention strategies, resulting in a responsive and evolving educational environment. Referring now to FIG. 2B as well as FIG. 1, in the learning embodiment, the suggestions are shown only to presenter 102 and is done concisely through a small visual cue 207, which indicates a need to slow down.

Referring now to FIG. 2B, FIG. 4, and FIG. 5 as well as FIG. 1, in the embodiments where confused button 402 is deactivated, an asynchronous step 540 allows presenter 102 to reset the system. This will typically occur after presenter 102 has had the opportunity to address the confusion as needed and actuated button 206 on controller interface 200. This reset reactivates confused button 402 in a step 542 for all the listeners, including listener 102. The reset can be accomplished through a direct message sent from database and centralized computing system 110 to client interface 400 using such technology as websockets or polling techniques or any other methods well known to those skilled in the arts.

Referring now also to FIG. 3A and FIG. 3B as well as FIG. 1 and FIG. 5, The reset action returns control to step 506 which then resets status tracker which is visualized in step 506 as the reset of confused visual cue 306 to back to satisfied visual cue 304. Control then continues at step 508 to visualize the reset status tracker and to listen for activities by presenter 102 or listener 142 at step 510.

Referring now to FIG. 1 and FIG. 4B, in the preferred embodiment, the system of the present invention additionally includes a comment button 404 to allow listener 142 to initiate an interaction anonymously with presenter 102. Listener 142 can actuate comment button 404 to initiate an interface to type and send a question or comment to database and centralized computing system 110. Such an interface can be another screen with a text entry box, or a list of possible questions to choose from, a combination of the two, or some other way of sending a question well known to those skilled in the arts. Referring now to FIG. 2C as well as FIG. 4B, any comment or question sent by listener 142 will be displayed in a text area 208 in controller interface 200. The identity of the author is not revealed but the question or comment can be read by presenter 102 who may choose to respond to it, as needed, without needing a public exchange.

In an feedback embodiment, where listener 142 is able to initiate an interaction anonymously with presenter 102, presenter 102 can judge that some set of questions are nonsensical or offensive and can, without the need to identify listener 142, instruct database and centralized computing system 110 to flag the author of the undesired questions. In the feedback embodiment, the system of the present invention can send a message to the offending author through their device to warn them of the flagged status without revealing their identity to presenter 102. Any number of actions can be taken by presenter 102 in response to undesired transmission by some listener without necessarily revealing the identity of the listener to presenter 102, such as having client interface 400b appear visually different with a darker background color or disabling client interface 400b temporarily. Alternatively, in some embodiments, presenter 102 can choose to reveal the offending listener by having client interface 400b emit an audible sound. Many options are available for modifying a user interface to indicate a warning state exists as a result of user actions that are not encouraged and are well known to those skilled in the arts.

In an assessment embodiment, listener 142 may be asked to enter their name and other identifying information but, in order to keep the system anonymous otherwise, the personally identifiable information can be stored in a second database and centralized computing system 111 separate and distinct from database and centralized computing system 110. Access privileges may be different so that even presenter 102 will not be able to access the information. However, administration personnel, other parties, or automated systems may be able to associate the questions, comments, and stored responses in database and centralized computing system 110 with the personally identifiable data stored in second database and centralized computing system 111 to store assessment records in a way that complies with privacy concerns. By having second database and centralized computing system 111, the standalone system of the present invention can be augmented to contribute in course assessment if the presentation is educational.

In the preferred embodiment, teachers are provided with audience polling tools, enabling them to create and launch questions dynamically, enhancing responsiveness to real-time classroom needs. Referring now to FIG. 1 and FIG. 2D, controller interface 200 provides an ability to spontaneously ask the audience a multiple choice question. A question box 210 allows presenter 102 to optionally type in a question for viewing by the audience if a verbally delivered question does not suffice. For multiple choice questions with two choices, such as Yes/No questions, presenter 102 would actuate two-choice button 212 to begin the question. For questions with three choices, presenter 102 would actuate three-choice button 213 to begin the question. For questions with four choices, presenter 102 would actuate three-choice button 214 to begin the question. Other number of choices, potentially pre-set questions, and a text area for presenter 102 to type in choice text can also be offered using substantially the same mechanism and can be realized by those skilled in the arts.

Once a button representing the number of choices is pressed, database and centralized computing system 110 will record the starting of a question with the given number of choices chosen. Referring now to FIG. 1 and FIG. 4C as well as FIG. 2D, client interface 400c receives notification of the update in database and centralized computing system 110 for the current presentation session. This notification can be received by client interface 400 through the pooling of database and centralized computing system 110 to monitor any modification of the presentation situation. Alternatively, the notification can be received via a message sent from database and centralized computing system 110 to client interface 400 when the question is begun by presenter 102. In general, there are numerous ways active processes can notify each other of state change and such approaches are well known to those skilled in the arts. As an exemplary case, if presenter 102 had chosen a three-choice question, thereby actuating three-choice button 213 and sending off a notification to database and centralized computing system 110 which then notifies client interface 400c, client interface 400c will display an option 1 button 406, an option 2 button 408, and an option 3 button 410.

Referring now to FIGS. 4A and 4B, as well as FIG. 4C and FIG. 1, in the preferred embodiment when listener 142 makes a choice and selects option 1 button 406, option 2 button 408, or option 3 button 410, client interface 400c will revert to client interface 400a. In other embodiments, client interface 400c will revert back to client interface 400b. In still other embodiments, client interface 400c may remain in place to offer listener 142 the ability to change to another option.

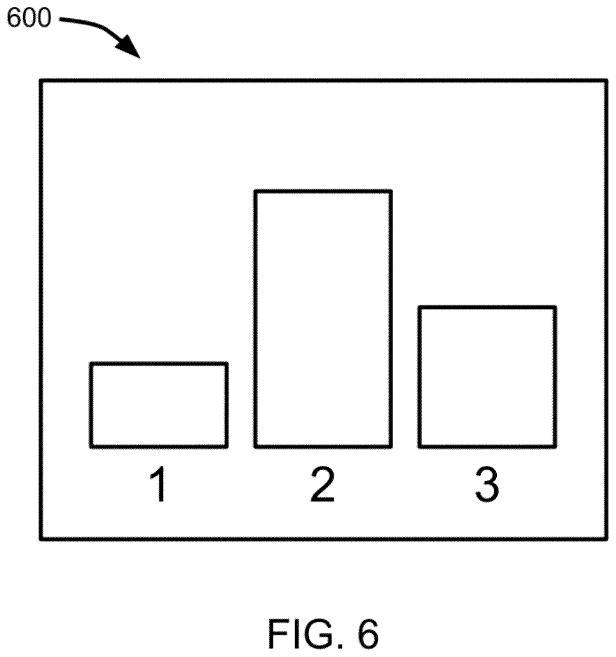

Referring now to FIG. 6 as well as FIG. 3, shared view 300 will now include a shared visualization 600 that reflects, in real time, the number of listeners who have responded to the multiple choice question and have selected one of the three choices. In the preferred embodiment, this shared visualization can be in the form of a bar chart while in other embodiments, it can be in the form of a pie chart and in still other embodiments, it can be numerical form or a combination of charts and numbers. In general, database and centralized computing system 110 may be configured to generate different types of visual representations based on the presenter's preference or the nature of the session. The visualization options may include, but are not limited to bar graphs, heatmaps, pie charts, line charts, the wide variety of possibilities available for presenting results of the votes by audience of listeners 140 as a visualization being well known to those skilled in the arts.

In addition to multiple choice questions, many other forms of interaction may be chosen by the presenter to offer to the audience to realize a more interactive presentation. This may use the same system to enter a question state by the presenter so that the audience can see options to respond with choice selection, or the entry of words, or other forms of response. While the invention has been described with respect to exemplary embodiments, one skilled in the arts will recognize that numerous modifications are possible based on the system described. For example, an aggregate of the embodiments can be combined as one embodiment that would offer a combination of the described listener confusion button feature and the described multiple choice response feature. Therefore, though various embodiments of the present system have been described herein, it is to be understood that such disclosure is not intended to be limiting. Various alterations and modifications will be readily apparent to those of skill in the art. Accordingly, it is intended that the appended claims be interpreted as covering all alterations and modifications as fall within the spirit and scope of the invention.

I claim:

1. A method for enhancing information flow during interactive sessions involving a presenter and a plurality of listeners, the method comprising the steps of:
a. Logging into a new session by said presenter on at least one presenter computing device through a presenter interface visible exclusively to said presenter.
b. Initializing a status tracker on a centralized computing system communicatively coupled to said presenter computing device in response to logging into said new session.
c. Generating a session access code for said new session on said centralized computing system.
d. Displaying said session access code on a shared display visible to said presenter and said plurality of listeners.
e. Displaying a dynamic visualization of said status tracker on said shared display.
f. Connecting to said new session with at least one listener computing device using said session access code through a listener interface by a listener from said plurality of listeners.
g. Sending at least one status indicator value from said listener computing device to said centralized computing system.
h. Updating said status tracker based on said status indicator value.
i. Dynamically updating, in real time, said visualization to reflect updated values of said status tracker on said shared display.

2. The method as set forth in claim 1, wherein said shared display is synchronously viewable on personal displays of said plurality of listeners.

3. The method as set forth in claim 1, wherein said centralized computing system is configured to disable further status indicator value submissions from said listener computing device after initial transmission.

4. The method as set forth in claim 3, further including a step of resetting said status tracker by said presenter, thereby reactivating the ability for said listener computing device to transmit additional status indicator values.

5. The method as set forth in claim 1, further comprising the use of a second computing system, said second computing system disconnected from said centralized computing system and storing personally identifiable information of said listener, such that listener identity can only be determined by a trusted party with access to both said centralized computing system and said second computing system.

6. The method as set forth in claim 1, further comprising a means to provide behavioral feedback from said listener to said presenter computing device without revealing listener identity.

7. The method as set forth in claim 5, further comprising a means to enable said presenter computing device to send a response to said listener computing device without disclosing the identity of said listener.

8. The method as set forth in claim 1, wherein said visualization of the status tracker includes at least one of heatmaps, bar graphs, pie charts, or line charts, selectable by said presenter through said presenter interface.

9. The method as set forth in claim 1, further comprising generating analytical reports based on cumulative status indicator values received during the session, wherein said reports provide engagement metrics for said presenter.

10. The method as set forth in claim 1, wherein said centralized computing system uses machine learning algorithms to detect patterns in status indicator values and recommend session adjustments through said presenter computing device.

11. A system for enhancing information flow during interactive sessions involving a presenter and a plurality of listeners, the system comprising:
a. At least one presenter computing device having a presenter interface configured to be visible exclusively to said presenter.
b. A centralized computing system communicatively coupled to said presenter computing device, said centralized computing system including:
i. A status tracker initializer to initialize a status tracker in response to logging into a new session by said presenter.
ii. A session code generator to generate a session access code for said new session.
iii. A code transmitter to transmit said session access code for display on a shared display visible to said presenter and said plurality of listeners.
iv. A visualization module to display a dynamic visualization of said status tracker on said shared display.
c. At least one listener computing device including:
i. A connection module to connect to said new session using said session access code through a listener interface.
ii. A status indicator sender to send at least one status indicator value to said centralized computing system.
d. Wherein said centralized computing system further comprises an update controller to update said status tracker based on said status indicator value and dynamically update said visualization in real-time to reflect changes on said shared display.

12. The system as set forth in claim 11, wherein said shared display is synchronously viewable on personal displays of said plurality of listeners.

13. The system as set forth in claim 11, wherein said centralized computing system is configured to disable further status indicator value submissions from said listener computing device after initial transmission.

14. The system as set forth in claim 13, wherein said presenter computing device is configured to reset said status tracker and reactivate said listener computing device to allow additional status indicator values.

15. The system as set forth in claim 11, further comprising a second computing system, said second computing system disconnected from said centralized computing system and configured to store personally identifiable listener data, such that listener identity can only be determined by a trusted party with access to both computing systems.

16. The system as set forth in claim 11, further comprising a feedback component on said presenter computing device configured to display listener behavioral status without revealing listener identity.

17. The system as set forth in claim 15, wherein said presenter computing device is further configured to transmit a response to said listener computing device without revealing listener identity.

18. The system as set forth in claim 11, wherein said visualization module is configured to generate and display at least one of heatmaps, bar graphs, pie charts, or line charts, selectable by said presenter.

19. The system as set forth in claim 11, further comprising an analytics module configured to aggregate status indicator data and generate session engagement reports for said presenter.

20. The system as set forth in claim 11, wherein said centralized computing system includes an adaptive learning engine configured to analyze listener feedback and suggest session modifications in real-time.
